(19) United States
(12) Patent Application Publication
(10) Pub. No.: US 2018/0163806 A1
(43) Pub. Date: Jun. 14, 2018

(54) PROTECTIVE DEVICE FOR RECREATIONAL VEHICLE SLIDE OUT

(71) Applicant: Mark Mohn, Toronto, OH (US)

(72) Inventor: Mark Mohn, Toronto, OH (US)

(21) Appl. No.: 15/379,355

(22) Filed: Dec. 14, 2016

(51) Int. Cl. F16F 1/37; B60P 3/36

(52) U.S. Cl. CPC F16F 1/37; B60P 3/36; F16F 2230/0023; F16F 2224/0266; F16F 2224/025; B60Y 2410/114

(57) ABSTRACT

A protection device for a passerby to prevent injury from an extended section of the slide out of any mobile living quarters such as a recreational vehicle is disclosed. The slide out of the recreational vehicle comprises an L-shaped tubular member with a hollow inner section to conformingly fit the lower sides of the external sharp sections. The tubular member is configured to be fixedly attached to the lower sides of the sharp edge. The tubular member is made from a cushioning material configured to provide head protection to a passer-by walking near the recreational vehicle.

### FIELD OF THE INVENTION

The present invention is directed to a protection device for a recreational vehicle slide out and, in particular, relates to an improved method, and apparatus for deploying and protecting the passerby from the slide out corners and edges of the recreational vehicle.

### BACKGROUND OF THE INVENTION

Recreational vehicles (RVs) are capable of transporting and comfortably sheltering people for extended periods. An RV includes a vehicle equipped with a living space and amenities similar to a home. An RV can be customized with extra room or space based on the user's requirement. Extendable features are added to the recreational vehicles to increase interior living space. The extendable features are made such that they can retract inside when the vehicle is in motion and expands outwards when the vehicle is parked.

In general, the typical extendable structure of the slide out comprises a plurality of walls to form the supplemental living space therein and an opening provides access to the supplemental living space. Normally, the sharp exterior edges of the extended slide out can pose a potential safety hazard for a person walking around the outside the vehicle. Sometimes, the extended length of the slide out can cause accidents when a user walking or passing by accidentally bumps into the exposed sharp lower edges of the slide out. This can lead to a fatal head injury as well as being cut or bruised.

Existing prior arts such as U.S. Pat. No. 7,226,116 discloses a mobile recreational vehicle having shortened full-length slide outs to allow for additional side ceiling support, and having slide out openings with minimal vertical supports. The sidewall ceiling support comprises horizontal members, vertical members and cross-brace types of protectors, which increase cost, time, labor, and materials for manufacturing the vehicle.

Existing prior arts describe the flexing walls of the recreational vehicle with respect to the slide out opening, which causes deformation of the interface between the walls and the slide out. This deformation may weaken the slide out, which in turn effects the retracted configuration.

In view of the foregoing disadvantages inherent in the known types of slide out protectors now present in the prior art, the present invention provides an improved slide out head protector to protect motor homes, and travel trailers that are adapted to expand in size to increase the effective interior living space of the vehicle. As such, the general purpose of the present invention, which will be described subsequently in detail, is to provide a device and method of protecting the passerby by implementing a novel slide out design.

### SUMMARY OF THE INVENTION

The present invention is directed to a slide out protector for a recreational vehicle configured to protect a plurality of sharp sections on the extended section of the slide out. The protection device comprises an L-shaped tubular member having a hollow inner section to conformingly fit the lower side of the sharp section. The tubular member is configured to be fixedly attached to the lower side of the sharp edge and the tubular member is made from a cushioning material configured to provide protection to a passerby from the extended section of the slide out of the recreational vehicle.

According to one preferred embodiment, a method to protect a plurality of sharp external sections of a recreational vehicle slide out comprising an L-shaped tubular member having a hollow inner section. The hollow inner section is fitted to the lower side of the sharp sections, and fixedly attaches the tubular member to the lower side of the sharp edges. The tubular member is made from a cushioning material to provide head protection to the passerby from the extended section of the slide out of the recreational vehicle.

In one preferred embodiment, the slide out protector described in this invention is made of a pliable, resilient, non-abrasive, and lightweight material. This material is selected from at least one of a rubber and a foam. The slide out protector is easy to manufacture, portable and lightweight.

Further novel features and other objects of the present invention will become apparent from the following detailed description, discussion and the appended claims, taken in conjunction with the drawings.

### BRIEF DESCRIPTION OF DRAWINGS

FIG. 1 is a front view of an exemplary slide out head protector attached to the sharp edge of the recreational vehicle according to an embodiment.

FIG. 2 shows an L-shaped tubular member attached to the sharp edge of the recreational vehicle according to an embodiment.

FIG. 3 shows aside view slide out head protector attached to recreational vehicle according to an embodiment

### DETAILED DESCRIPTION OF THE INVENTION

The following detailed description of the different exemplary embodiments presents a description of certain specific embodiments to assist in understanding the claims. However, the present invention is intended to cover alternatives, modifications and equivalents, which maybe included within the spirit and scope of the invention as defined by the appended claims.

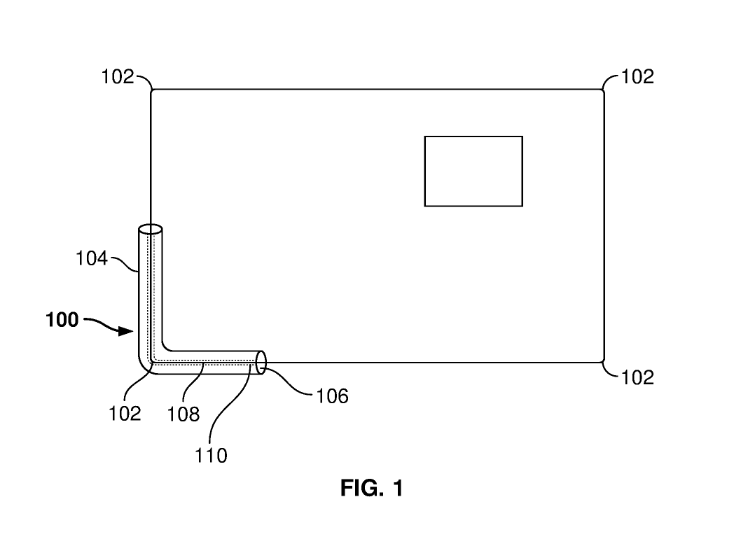

According to FIG. 1, a slide out head protection device 100 for a passerby protection from one or more extended sections of the slide out of a mobile living quarters (not shown in figure), such as a recreational vehicle 112, is generally illustrated. The slide out head protection device 100 comprises an L-shaped tubular member 104 to protect a plurality of sharp sections 102 in one or more extended sections of the slide out of the recreational vehicle 112. The L-shaped tubular member 104 is configured to have a hollow inner section 106 to conformingly fit the lower side 108 of the sharp section 102. The tubular member 104 is configured to be fixedly attached to the lower side 108 of the sharp sections 102. The tubular member 104 is made from a cushioning material configured to protect the passerby from the external sharp extended sections of the slide out of the recreational vehicle 112.

In the slide out head protection device 100 the tubular member 104 is properly aligned with the slit or hole, such that the slide out room is moved into the retracted position to prevent the passerby being hurt or injured. For example, manufacturers of recreational vehicles 112 commonly place slide outs along the length of the vehicle with the sharp section 102 To adjust the slide out room with respect to the sharp section 102, the slide out head protection device 100 is made of a cushioning material selected from a rubber or foam which can protect the passer-by from head and upper body injuries when the slide out room is in the retracted position such that the entire edges properly register with the slit.

In a preferred embodiment, with reference to FIG. 1, the mechanism generally comprises a lengthwise slit through which the tubular member 104 is placed around the sharp section 102 of the lower corner assembly. The slide out head protector 100 is easily detachable such that it is easily removable or releasable in nature. The dimension of slide out head protection device 100 is 2¼ inches in diameter. The L-shape has a half inch hold in the middle section, which is configured to have a cylinder L-shape. In a preferred embodiment, the L-shaped tubular member 104 has as a split and that split slides on the slide out head protection device 100 of the recreational vehicle 112. A length of the horizontal side is two to three feet and a length of the vertical side is three to four feet. The slide out head protection device 100 split is applied when the recreational vehicle 112 is parked. The slide out head protection device 100 is removable without the advent of any attachment mechanism and due to the pressure created the slide out head protection device The slide out head protection device 100 is removed before the slide out is closed.

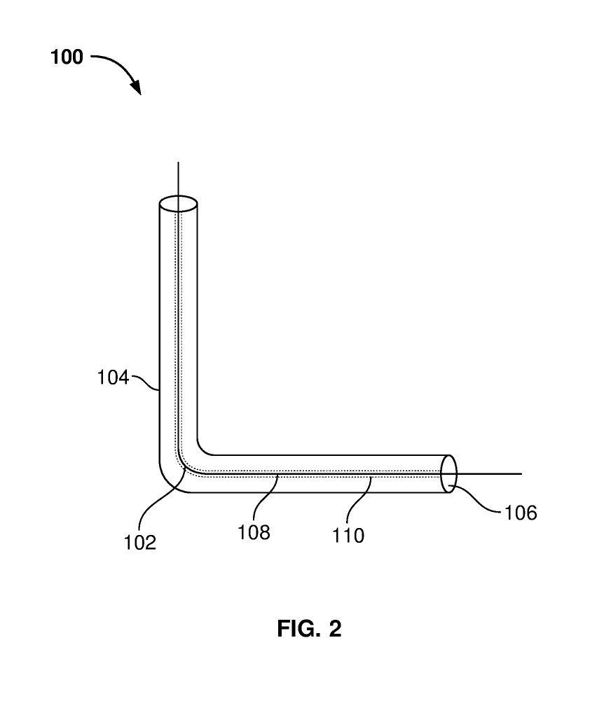

According to FIG. 2, which shows a tubular member 104 of the slide out head protector 100 attached to the external sharp edge of the recreational vehicle 112 according to an embodiment. The tubular member 104 is securely attached to the lower sharp section 102 on either sides of a slide out structure. The slide out head protection device 100 is mounted on all slides. In addition, the slide out head protection devices 100 is located adjacent to each sharp section 102 of the retractable room. The tubular member 104 can be made from different colors based on the color scheme of the recreational vehicle 112. The center of the tubular member 104 is configured to be one half inch in diameter. The dimension of the tubular member is 1-2 inches in breadth, and is 2¼ inches in diameter with a ½ inch hole in center and vertical is 3-4 feet and horizontal is 2-4 feet. The slide out head protection device 100 can serve as padding along the entire lower corner of the slide out. If any person accidentally walks into the slide out, the cushioning member of the slide out head protection device 100 protects them from getting hurt from the sharp edges. The slide out head protection device 100 can be used in all types of recreational vehicles, which includes also travel trailers, fifth wheels, campers, various other conventional types of trailers, motor homes, and the like. The slide out head protection device 100 can be manufactured separately for each lower section or both lower corners of the slide out. The slide out head protection device 100 is mainly used to protect the head and eyes and uppy body of the passerby when an RV (recreation vehicle) 112 slide out is extended.

According to one preferred embodiment, is a method to protect a plurality of sharp sections 102 in a recreational vehicle 112 is disclosed. The method comprising providing an L-shaped tubular member 104 having a hollow inner section and conformingly fitting the hollow inner section 106 to the lower side 108 of the external sharp section 102. The tubular member 104 is fixedly attached to the lower side 108 of the sharp section 102, and to the hollow inner section of the tubular member 104. The tubular member 104 is made from a cushioning material to provide head protection to a passerby near the recreational vehicle 112.

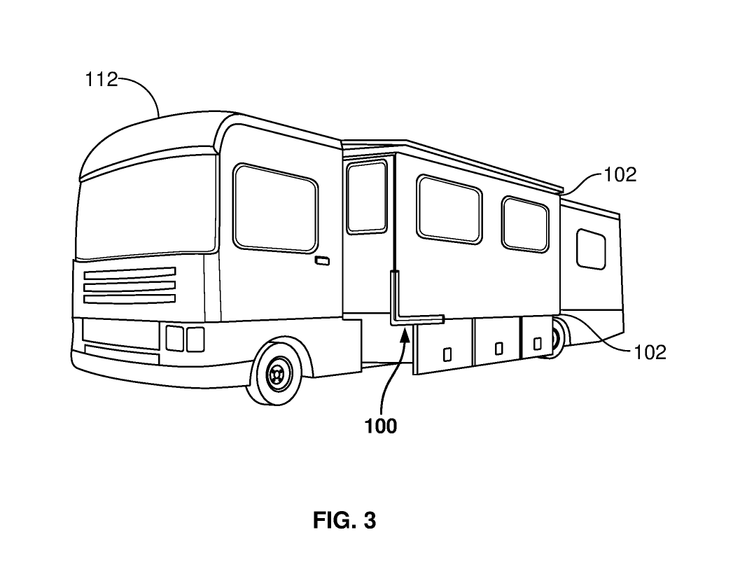

According to FIG. 3, shows a side view slide out head protector 100 attached to are recreational vehicle 112 according to an embodiment. The slide out protector 100 is attached or such that the closing and opening of the room extension is made easy. The slide out protector 100 is easily removed and during retraction of the extension room, the slide out protector is easily closed. The recreational vehicle 112 natural surface friction serves to hold the slide out protectors onto the edge or corner to which it is attached.

In one preferred embodiment, the slide out head protection device 100 can be applied easily to any kind of recreational vehicle 112, which ensures safety and convenience for the passerby. The slide out head protection device 100 covers the sharp lower sides 108 of a slide out with padding. The slide out head protection device 100 can be installed without special tools, drilling or fasteners. The slide out head protection device 100 is lightweight, portable, corrosion resistant, affordable and readily adaptable to a variety of RVs 112 with slide out room extenders.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

The reference numbers recited in the below claims are solely for ease of examination of this patent application, and are exemplary, and are not intended in any way to limit the scope of the claims to the particular features having the corresponding reference numbers in the drawings.

I claim:

1. A protection device for a plurality of sharp sections in a recreational vehicle comprising:
an L-shaped tubular member comprising a hollow inner section to conformingly fit the lower side of the sharp section, wherein the tubular member is configured to be fixedly attached to a lower side of the sharp edge, and
wherein the tubular member is made from a cushioning material configured to provide head protection to a passer-by.

2. The protection device as claimed in claim 1, wherein the cushioning material is a rubber or foam.

3. The protection device as claimed in claim 1, wherein the tubular member is attached to the lower sharp edges on either sides of a slide out structure.

4. The protection device as claimed in claim 1, wherein the protection device is mounted on a slide out of the recreational vehicle.

5. The protection device as claimed in claim 1, wherein the vertical of the tubular member ranges from 3-4 feet.

6. The protection device as claimed in claim 1, wherein the horizontal of the tubular member ranges from 2-3 feet.

7. The protection device as claimed in claim 1, wherein the height of the tubular member ranges from 2 to 2¼ inches with a ½ inch hole that runs thru the center on the L-shape.

8. A method to protect a plurality of sharp sections in a recreational vehicle, the method comprising:
providing an L-shaped tubular member having a hollow inner section;
fitting the hollow inner section to the lower side of the sharp section;
attaching the tubular member to a lower side of the sharp edge, and protecting a passer-by via the tubular member made from a cushioning material.
